(19) United States
(12) Patent Application Publication
(10) Pub. No.: US 2026/0133858 A1
(43) Pub. Date: May 14, 2026

(54) STANDARDIZED FRAMEWORK FOR VEHICLE MANAGEMENT TASKS

(71) Applicant: Rivian IP Holdings, LLC, Irvine, CA (US)

(72) Inventors: Suhaib HASAN, Irvine, CA (US); Nicolas DIKEN, Palo Alto, CA (US)

(21) Appl. No.: 19/367,598

(22) Filed: Oct. 23, 2025

Related U.S. Application Data
(60) Provisional application No. 63/718,493, filed on Nov. 8, 2024.

(51) Int. Cl. G06F 9/54; G06F 11/30; G06F 11/34

(52) U.S. Cl. CPC G06F 9/547; G06F 11/3051; G06F 11/3423; G06F 2209/543

(57) ABSTRACT

Embodiments include a method of managing execution of real-time tasks in a multicore processor system. The method includes instantiating a plurality of task instances each associated with a task-specific configuration. The method further includes executing, by each task instance, one or more workers according to a predefined execution phase. The method further includes invoking a task-profiling callback associated with each task instance to record task-level performance data during execution, and invoking an intra-task profiling callback associated with each worker to record intra-task performance data within each execution phase. The method further includes synchronizing, by a global configuration, the task-level performance data and the intra-task performance data to provide unified profiling of the task instances executing across the cores.

### CROSS-REFERENCE TO RELATED APPLICATIONS

This application claims benefit of co-pending United States provisional patent application Serial No. 63/718,493 filed November 8, 2024. The aforementioned related patent application is herein incorporated by reference in its entirety.

### BRIEF DESCRIPTION OF THE DRAWINGS

FIG. 1A illustrates an example vehicle in accordance with certain embodiments.

FIG. 1B illustrates a chassis of a vehicle in accordance with certain embodiments.

FIG. 2A is a schematic block diagram of components of a vehicle in accordance with certain embodiments.

FIG. 2B is a schematic block diagram of alternative components of a vehicle in accordance with certain embodiments.

FIG. 3 is a schematic block diagram illustrating an asymmetric multicore processing (AMP) system in accordance with certain embodiments.

FIG. 4 is a schematic diagram illustrating data flow in an AMP system in accordance with certain embodiments.

FIG. 5 is a method of managing tasks within an AMP system in accordance with certain embodiments.

### DETAILED DESCRIPTION

In embedded applications such as vehicle systems, certain tasks are time-critical and require predictable, low-latency processing to maintain safe and reliable operation of the vehicle systems. Real-time operating systems (RTOS) may be used to provide more deterministic task execution, and may be run with minimal latency even on less powerful cores. In some cases, the RTOS may be run on low-power cores of an AMP system, while higher-power cores handle more computationally intensive tasks.

Embodiments described herein are directed to a standardized framework that provides task management to improve the conformity of RTOS tasks to scheduling algorithms, which facilitates the creation and execution of the RTOS tasks, and may further support improved logging and enforcement. In this way, the standardized framework enables embedded applications to execute in a deterministic manner, improving the predictability with which time-critical tasks are performed.

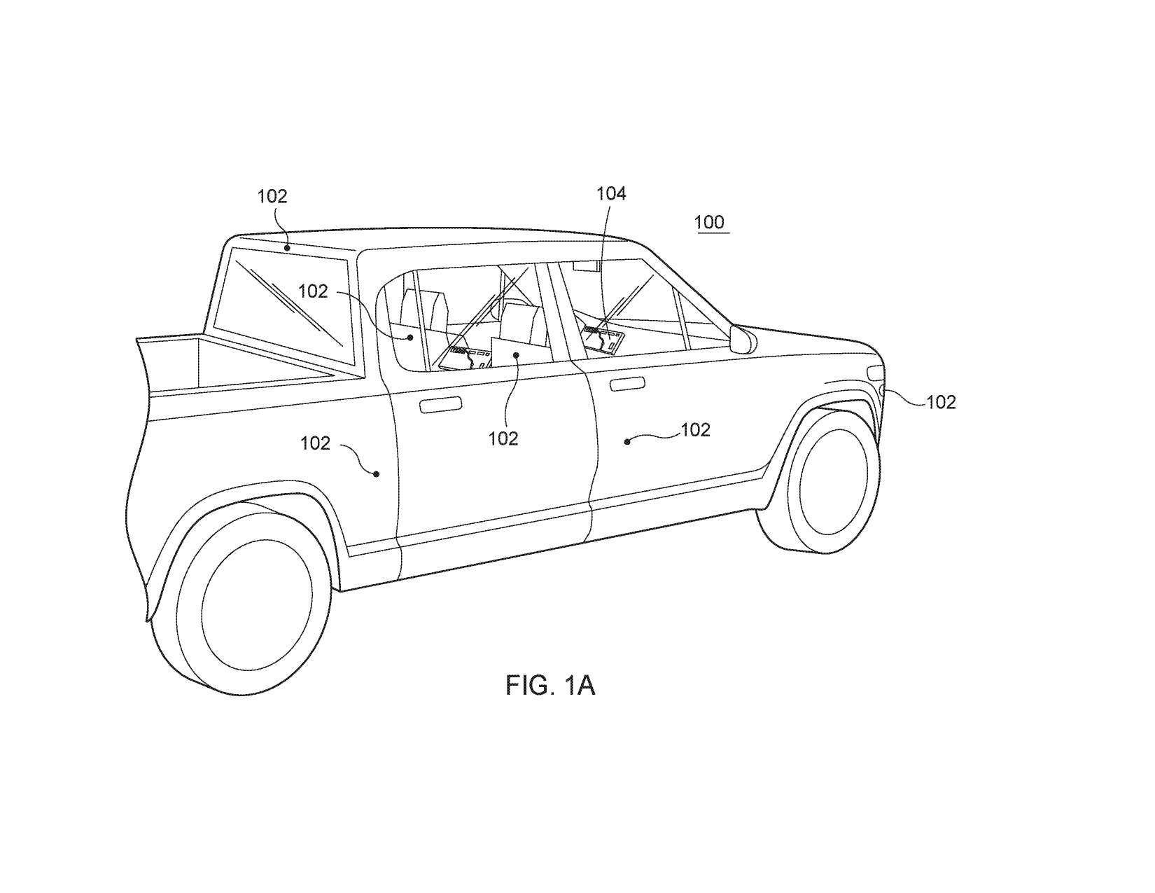

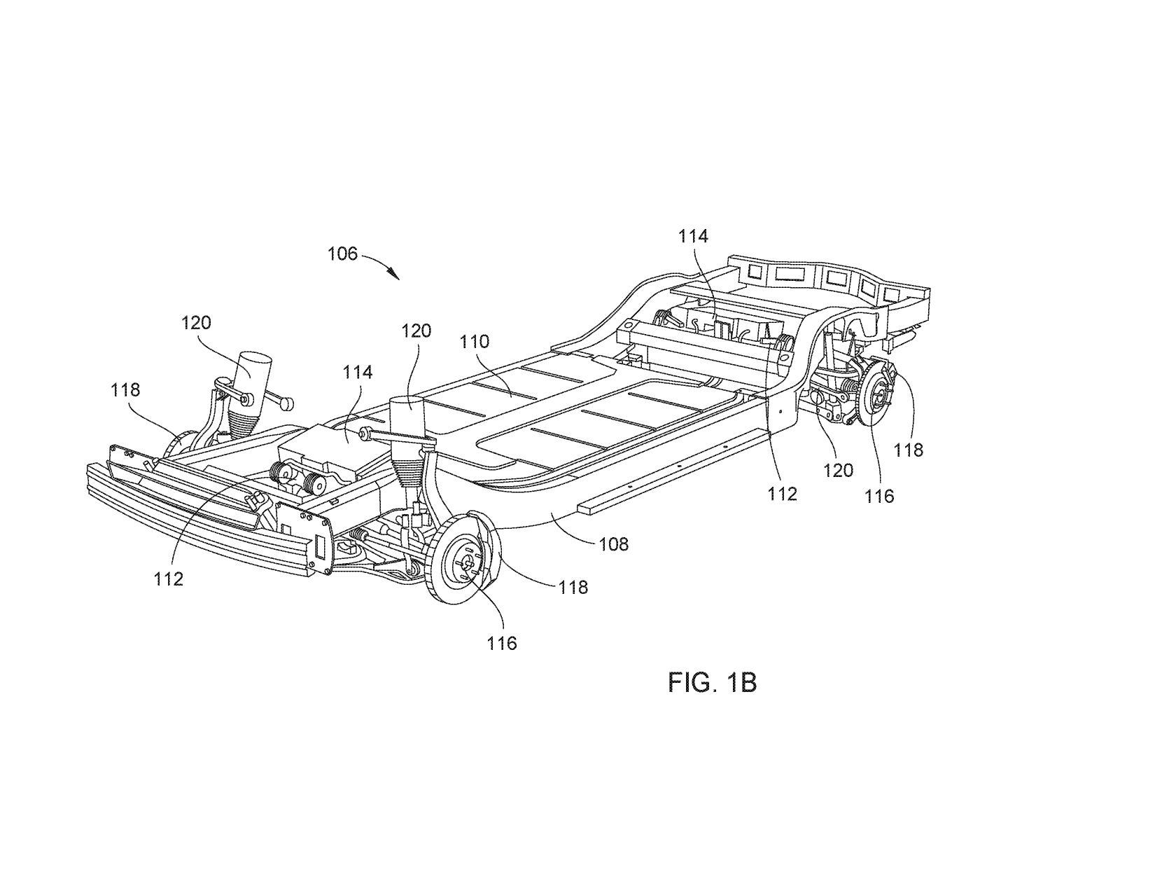

FIG. 1A illustrates an example vehicle 100. As seen in FIG. 1A, the vehicle 100 has multiple exterior cameras 102 and one or more front displays 104. Each of these exterior cameras 102 may capture a particular view or perspective on the outside of the vehicle 100. The images or videos captured by the exterior cameras 102 may then be presented on one or more displays in the vehicle 100, such as the one or more front displays 104, for viewing by a driver.

Referring to FIG. 1B, the vehicle 100 may include a chassis 106 including a frame 108 providing a primary structural member of the vehicle 100. The frame 108 may be formed of one or more beams or other structural members or may be integrated with the body of the vehicle (i.e., unibody construction).

In embodiments where the vehicle 100 is a battery electric vehicle (BEV) or possibly a hybrid vehicle, a large battery 110 is mounted to the chassis 106 and may occupy a substantial (e.g., at least 80 percent) of an area within the frame 108. For example, the battery 110 may store from 100 to 200 kilowatt hours (kWh). The battery 110 may be a lithium-ion battery or other type of rechargeable battery. The battery may be substantially planar in shape.

Power from the battery 110 may be supplied to one or more drive units 112. Each drive unit 112 may be formed of an electric motor and possibly a gear reduction drive. In some embodiments, there is a single drive unit 112 driving either the front wheels or the rear wheels of the vehicle 100. In another embodiment, there are two drive units 112, each driving either the front wheels or the rear wheels of the vehicle 100. In yet another embodiment, there are four drive units 112, each drive unit 112 driving one of four wheels of the vehicle 100.

Power from the battery 110 may be supplied to the drive units 112 by one or more sets of power electronics 114. The power electronics 114 may include inverters configured to convert direct current (DC) from the battery 110 into alternating current (AC) supplied to the motors of the drive units 112.

The drive units 112 are coupled to two or more hubs 116 to which wheels may mount. Each hub 116 includes a corresponding brake 118, such as the illustrated disc brakes. The drive units 112 or other component may also provide regenerative braking. Each hub 116 is further coupled to the frame 108 by a suspension 120. The suspension 120 may include metal or pneumatic springs for absorbing impacts. The suspension 120 may be implemented as a pneumatic or hydraulic suspension capable of adjusting a ride height of the chassis 106 relative to a support surface. The suspension 120 may include a damper with the properties of the damper being either fixed or adjustable electronically.

In the embodiment of FIG. 1B and in the discussion below, the vehicle 100 is a battery electric vehicle. However, the systems and methods disclosed herein may be used for any type of vehicle, including vehicles powered by an internal combustion engine (ICE), hybrid drivetrain, hydrogen fuel cell drivetrain, or other type of drivetrain that requires heating in preparation for use, such as diesel engines.

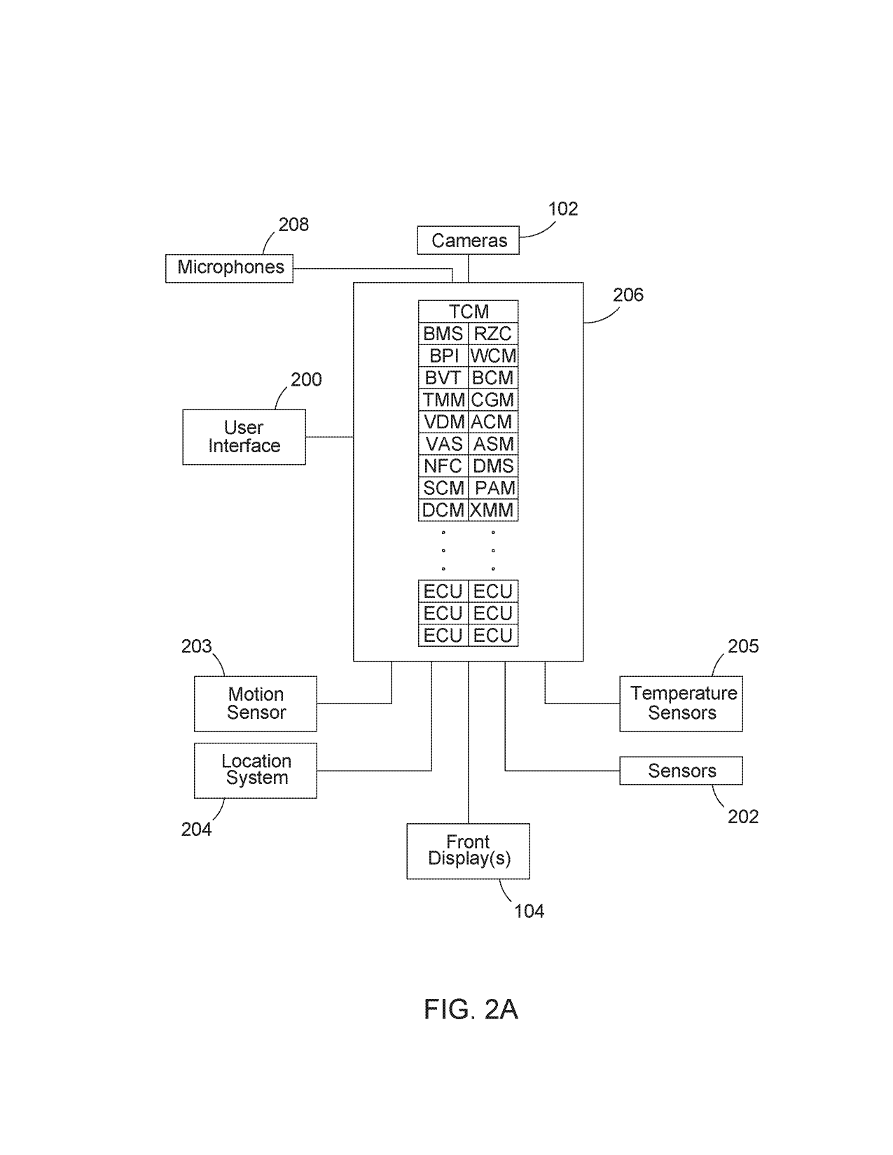

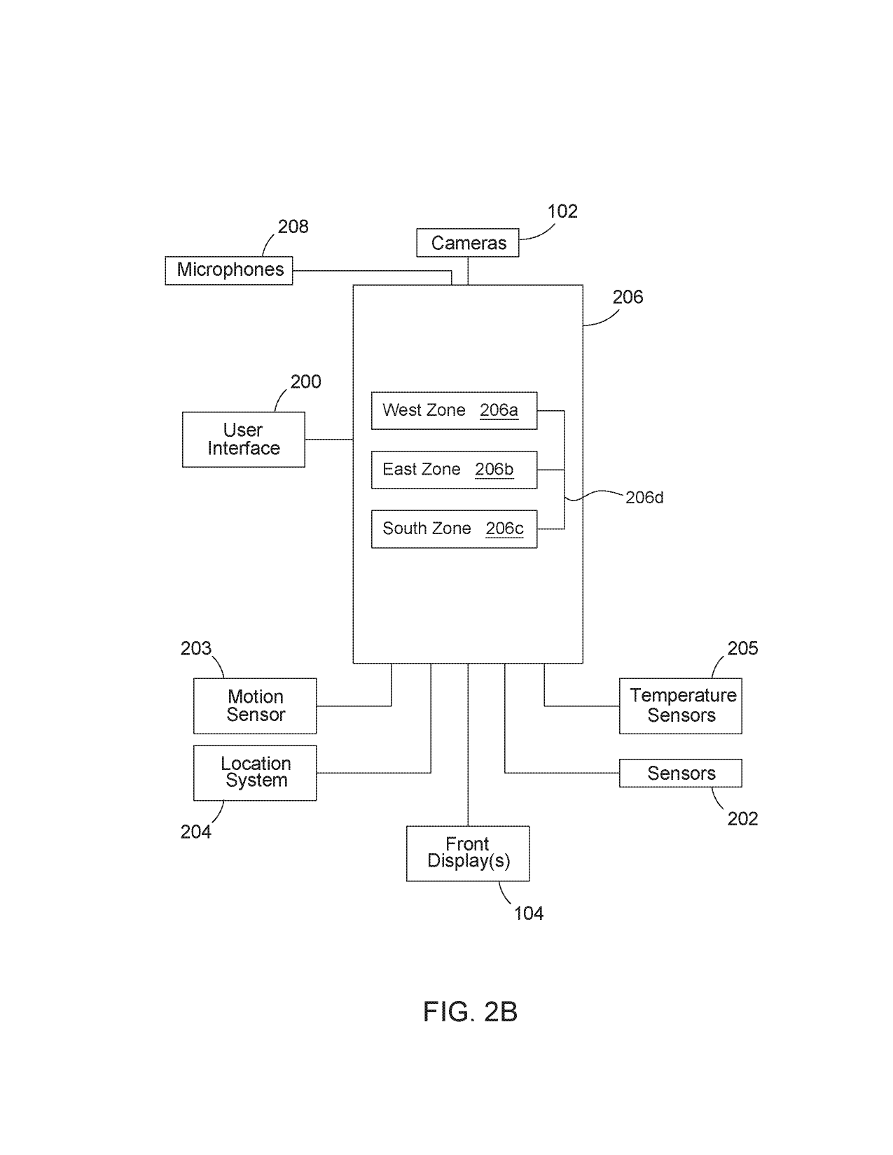

FIG. 2A illustrates example components of the vehicle 100 of FIG. 1A. As shown in FIG. 2A, the vehicle 100 includes the cameras 102, the one or more front displays 104, a user interface 200, one or more sensors 202, a motion sensor 203, and a location system 204. The one or more sensors 202 may include ultrasonic sensors, radio detection and ranging (RADAR) sensors, light detection and ranging (LIDAR) sensors, or other types of sensors. The location system 204 may be implemented as a global positioning system (GPS) receiver. The user interface 200 allows a user, such as a driver or passenger in the vehicle 100, to provide input.

The components of the vehicle 100 may include one or more temperature sensors 205. The temperature sensors 205 may include sensors configured to sense an ambient air temperature, temperature of the battery 110, temperature of power electronics 114, temperature of each drive unit 112 and/or each motor of each drive unit 112, or the temperature of any other component of the vehicle 100.

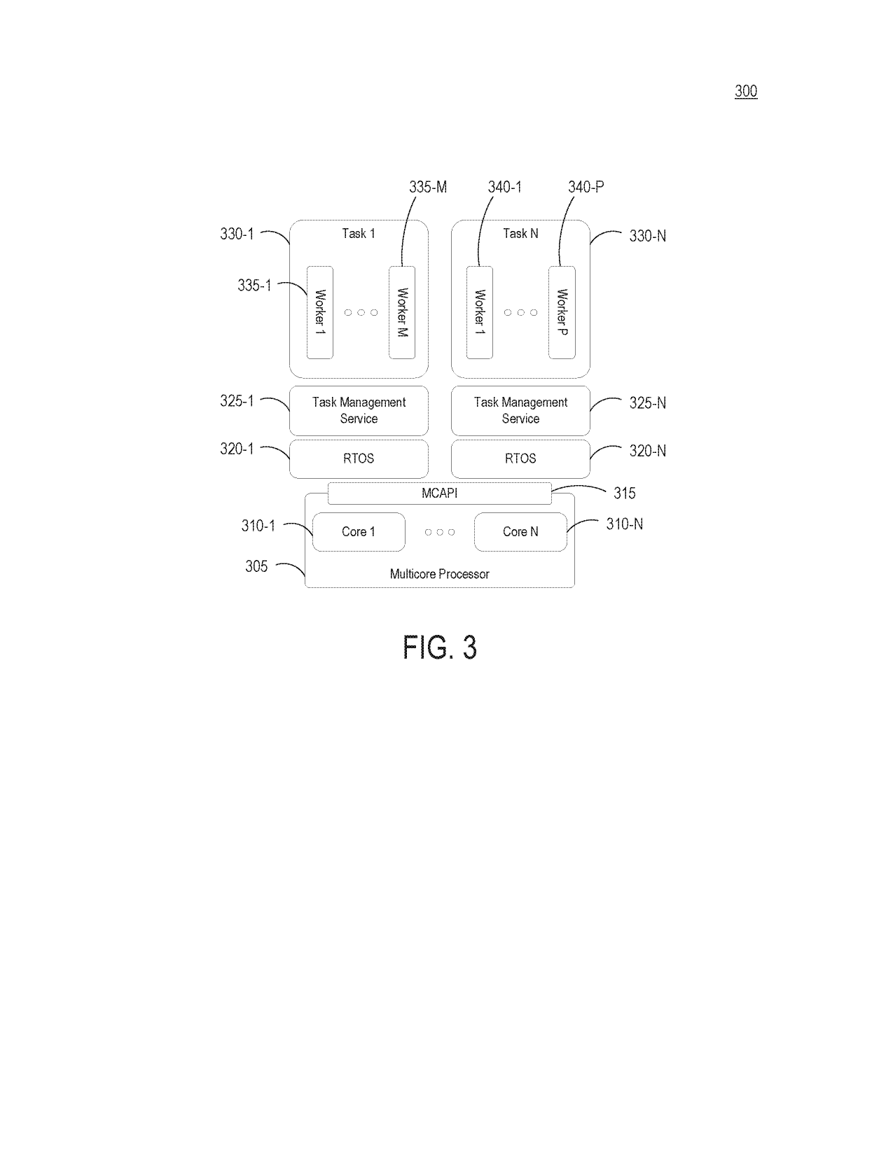

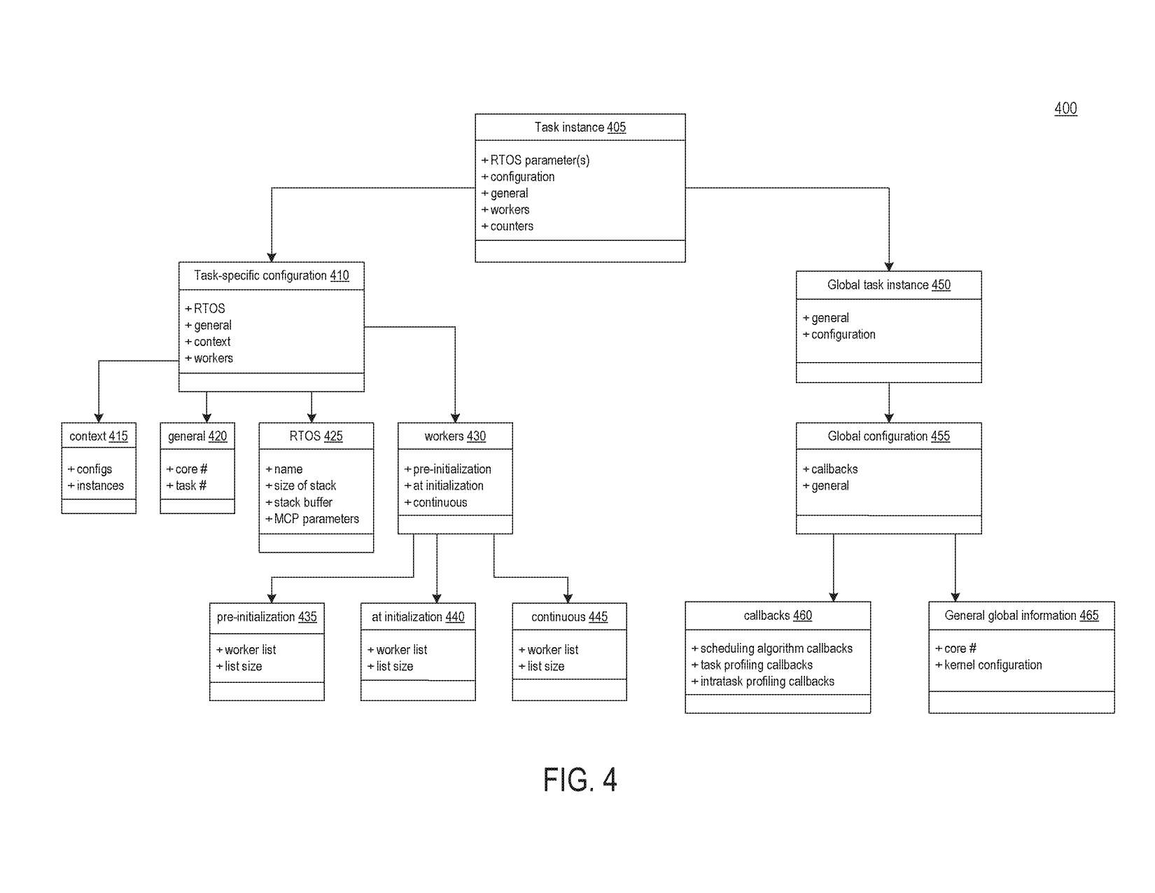

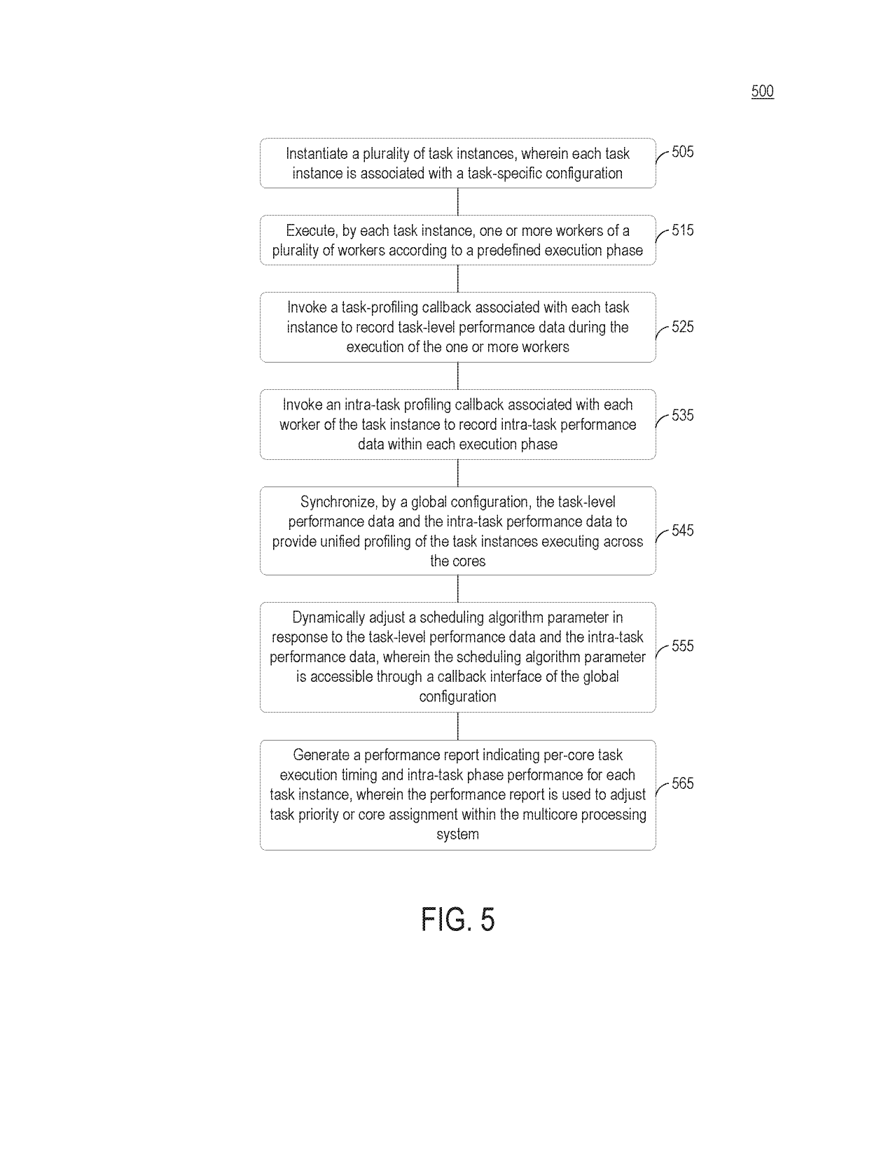

A control system 206 executes instructions to perform at least some of the actions or functions of the vehicle 100, including the functions described in relation to FIGS. 4 and 5. For example, as shown in FIG. 2, the control system 206 may include one or more electronic control units (ECUs) configured to perform at least some of the actions or functions of the vehicle 100, including the functions described in relation to FIGS. 3A to 3E. In certain embodiments, each of the ECUs is dedicated to a specific set of functions. Each ECU may be a computer system and each ECU may include functionality described below in relation to FIGS. 3A to 3E.

Certain features of the embodiments described herein may be controlled by a Telematics Control Module (TCM) ECU. The TCM ECU may provide a wireless vehicle communication gateway to support functionality such as, by way of example and not limitation, over-the-air (OTA) software updates, communication between the vehicle and the internet, communication between the vehicle and a computing device, in-vehicle navigation, vehicle-to-vehicle communication, communication between the vehicle and landscape features (e.g., automated toll road sensors, automated toll gates, power dispensers at charging stations), or automated calling functionality.

Certain features of the embodiments described herein may be controlled by a Central Gateway Module (CGM) ECU. The CGM ECU may serve as the vehicle’s communications hub that connects and transfer data to and from the various ECUs, sensors, cameras, microphones, motors, displays, and other vehicle components. The CGM ECU may include a network switch that provides connectivity through Controller Area Network (CAN) ports, Local Interconnect Network (LIN) ports, and Ethernet ports. The CGM ECU may also serve as the master control over the different vehicle modes (e.g., road driving mode, parked mode, off-roading mode, tow mode, camping mode), and thereby control certain vehicle components related to placing the vehicle in one of the vehicle modes.

In various embodiments, the CGM ECU collects sensor signals from one or more sensors of vehicle 100. For example, the CGM ECU may collect data from cameras 102 and sensors 202. The sensor signals collected by the CGM ECU are then communicated to the appropriate ECUs for performing, for example, the operations and functions described in relation to FIGS. 3A to 3E.

The control system 206 may also include one or more additional ECUs, such as, by way of example and not limitation: a Vehicle Dynamics Module (VDM) ECU, an Experience Management Module (XMM) ECU, a Vehicle Access System (VAS) ECU, a Near-Field Communication (NFC) ECU, a Body Control Module (BCM) ECU, a Seat Control Module (SCM) ECU, a Door Control Module (DCM) ECU, a Rear Zone Control (RZC) ECU, an Autonomy Control Module (ACM) ECU, an Autonomous Safety Module (ASM) ECU, a Driver Monitoring System (DMS) ECU, and/or a Winch Control Module (WCM) ECU. If vehicle 100 is an electric vehicle, one or more ECUs may provide functionality related to the battery pack of the vehicle, such as a Battery Management System (BMS) ECU, a Battery Power Isolation (BPI) ECU, a Balancing Voltage Temperature (BVT) ECU, and/or a thermal Management Module (TMM) ECU. In various embodiments, the XMM ECU transmits data to the TCM ECU (e.g., via Ethernet, etc.). Additionally or alternatively, the XMM ECU may transmit other data (e.g., sound data from microphones 208, etc.) to the TCM ECU.

Referring to FIG. 2B, in some embodiments, the control system 206 may be implemented as a plurality of zonal controllers 206a, 206b, 206c. Each zonal controller 206a, 206b, 206c may control a subset of systems of the vehicle. The subset of systems controlled by each zonal controller 206a, 206b, 206c may be generally assigned based on location within the vehicle 100. For example, a west zonal controller 206a may control systems on a driver side of the vehicle 100, an east zonal controller 206b may control systems on a passenger side of the vehicle 100, and a south zonal controller 206c may control systems in a rear portion of the vehicle. Each zonal controller 206a, 206b, 206c may implement a portion of the functions ascribed to the ECUs of the control system 206 of FIG. 2A. The functions of the ECUs may be distributed among the zonal controller 206a, 206b, 206c such that only one zonal controller 206a, 206b, 206c implements the functions of each ECU. Alternatively, the functions of an ECU may be duplicated across multiple zonal controllers 206a, 206b, 206c, each zonal performing the functions of the ECU for the portion of the vehicle to which that zonal controller 206a, 206b, 206c is assigned.

The zonal controllers 206a, 206b, 206c may be connected to one another by a network 206d, such as an Ethernet network, controller area network (CAN), or other type of network.

FIG. 3 is a schematic block diagram illustrating an asymmetric multicore processing (AMP) system 300 in accordance with certain embodiments. The AMP system 300 comprises a multicore processor 305 having any suitable implementation. In some embodiments, the multicore processor 305 may be implemented in the control system 206 of FIGS. 2A, 2B, and may encompass at least one of the ECUs. In some embodiments, the plurality of cores 310-1, …, 310-N may be homogenous (i.e., having a same architecture). In other embodiments, the plurality of cores 310-1, …, 310-N may be heterogeneous, and may differ in terms of performance, power consumption, and specialization. In some embodiments, at least some of the plurality of cores 310-1, …, 310-N are “little” cores that are designed to efficiently handle low-power tasks. In some embodiments, one or more of the plurality of cores 310-1, …, 310-N also include one or more “big” cores that are designed for performance of more intensive computational tasks.

In some embodiments, a Multicore Communications API (MCAPI) 315 provides a standardized communication interface across the plurality of cores 310-1, …, 310-N. The MCAPI 315 is particularly beneficial in the AMP system 300, as various cores 310-1, …, 310-N may have different architectures, and may run different operating systems and/or software stacks. The MCAPI 315 generally supports low-latency message and data transmission between the cores 310-1, …, 310-N, and in some cases may define a shared memory space to support efficient sharing of data.

As shown, in various embodiments, the cores 310-1, …, 310-N each run a respective RTOS 320-1, …, 320-N. In other embodiments, one or more of the cores 310-1, …, 310-N may run different type(s) of OS, e.g., a “big” core that runs a general-purpose OS such as Linux. The RTOS 320-1, …, 320-N may have any suitable implementation, but are typically lightweight (designed to run efficiently on low-power cores) with minimal latency. The RTOS 320-1, …, 320-N improves the predictability of task execution in the AMP system 300, ensuring that critical tasks can meet timing deadlines.

In some embodiments, the cores 310-1, …, 310-N each run a task management service 325-1, …, 325-N as a layer above the RTOS 320-1, …, 320-N. The task management service 325-1, …, 325-N, which will be discussed in greater detail below, generally represents a comprehensive set of task management functions and/or other code that extends the functionality of the RTOS layer.

Each of the cores 310-1, …, 310-N performs a respective one or more tasks, each comprising one or more workers. As shown, the core 310-1 performs a task 330-1 having workers 335-1, …, 335-M, and the core 310-N performs a task 330-N having workers 340-1, …, 340-P. The numbers of workers for a particular task 330-1, …, 330-N may vary depending on the functionality provided by the task. In some embodiments, each of the tasks 330-1, …, 330-N represents an application for operating and/or managing a vehicle system, and the workers 335-1, …, 335-M, 340-1, …, 340-P represent threads of the application that control some aspect of the vehicle system (which in some cases may correspond to the control of an entire subsystem). The multicore processor 305 may assign the tasks 330-1, …, 330-N to the cores 310-1, …, 310-N using any suitable techniques, which may depend on factors such as power consumption, performance requirements, thermal limits, and so forth.

As mentioned above, the task management service 325-1, …, 325-N provides comprehensive task management functionality to the RTOS 320-1, …, 320-N. The task management service 325-1, …, 325-N performs one or more of the following: managing global and task-specific initialization, controlling task creation and task execution to conform with a scheduling algorithm, providing and exposing profiling at the task and/or worker context, and streamlining error handling during runtime of the task.

In some embodiments, the task management service 325-1, …, 325-N provides global configuration for each instance of the RTOS 320-1, …, 320-N. Refer also to FIG. 4, which is a schematic diagram illustrating data flow in an AMP system such as the AMP system 300. Each instance of the tasks 330-1, …, 330-N may include a pointer to its task-specific configuration as well as a pointer to its global task instance to specify which core the instance is running on and which callbacks are needed.

The global configuration of the task includes callback information defining one or more callbacks of one or more types, and further includes general global configuration information such as a core number (or other identifier) of the global task instance.

In some embodiments, the one or more callbacks include one or more scheduling algorithm callbacks that define a type of the scheduling algorithm that is applied across the tasks 330-1, …, 330-N. Any suitable type of scheduling algorithm is contemplated: rate monotonic, round-robin, deadline driven, and so forth. In some cases, conforming the tasks to the scheduling algorithm in this manner may be effective to replace some of the more complex scheduling capabilities available through the RTOS 320-1, …, 320-N.

The one or more callbacks optionally include one or more task profiling callbacks that provide information about the processing load and/or memory consumption of the tasks 330-1, …, 330-N. The one or more callbacks optionally include one or more intra-task profiling callbacks that provide information about the processing load and/or memory consumption of initialization and step functions within the tasks 330-1, …, 330-N.

In some embodiments, the task management service 325-1, …, 325-N provides task-specific configuration for each of the tasks 330-1, …, 330-N. As shown, each of the tasks 330-1, …, 330-N may be considered a unique entity that requires a specialized configuration by the task management service 325-1, …, 325-N. In some embodiments, the task-specific configuration includes: one or more RTOS parameters representing configuration parameters of the RTOS during creation of the task (such as a name, a size of a stack, a buffer for the stack, one or more parameters of the multicore processor 305); general configuration information such as a core number (or other identifier) and task number (or other identifier) of the task; context information that includes additional configuration information and/or instances used for task profiling and scheduling algorithm configurations; and workers (e.g., task callbacks).

In some embodiments, the workers comprise one or more workers (e.g., the workers 335-1, …, 335-M, 340-1, …, 340-P) that run prior to initialization of the task, at the initialization of the task, and/or continuously during execution of the task. In some embodiments, each of the workers includes a list of worker contexts, and each item in the list includes a callback where the execution of the worker will occur.

In some embodiments, the flow of control begins with initialization of the global instance of the task management service 325-1, …, 325-N. Each of the tasks 330-1, …, 330-N receives an initialization that validates the configuration of the task, creates the task, and performs any additional setup routines. The global configuration that is provided by the task management service 325-1, …, 325-N ensures that the tasks 330-1, …, 330-N conform to the respective scheduling algorithm, and may be further used to setup task profiling.

In some embodiments, the flow of control continues using a main task handler that continuously iterates over step callbacks while maintaining conformity to the respective scheduling algorithm (and optionally profiling the step callbacks). In some embodiments, upon encountering a task critical error, such as passing an incorrect task instance or a failure message returned from a worker, the task critical error may be blocked by the error handler to prevent any disruption of the system. The error handler may then enter an infinite loop, calling an optional global callback that informs the user of the task critical error.

FIG. 4 is a schematic diagram 400 illustrating data flow in an asymmetric multicore processing (AMP) system in accordance with certain embodiments. For example, each task management service 325-1, …, 325-N may organize and manage real-time tasks using the class structure depicted in the diagram 400.

The diagram 400 includes a task instance object 405 representing a real-time task, during execution, that is managed by a corresponding task management service 325-1, …, 325-N. The task instance 405 aggregates: RTOS parameters 425; a task-specific configuration 410 containing references to runtime behavior and context objects; general information 420 including a core number and task identifier; a plurality of workers 430, each representing a collection of executable functions divided into discrete operational phases; and one or more counters that are used to record profiling data such as execution duration, latency, and jitter.

During execution, each task instance 405 receives control from a scheduler of the corresponding core and performs the corresponding worker routines in accordance with the current phase of operation. Each task instance 405 is coupled to profiling callback functions that measure performance at both the task level and the intra-task level.

The task-specific configuration 410 defines the parameters and runtime environment for the associated task instance 405. The task-specific configuration 410 includes a context object 415 that acts as a container that maintains associations between multiple task-specific configurations 410 and task instances 405. Within the multicore processing system, each task management service 325-1, …, 325-N maintains a local context, while a global configuration 455 synchronizes the collective contexts across all cores. Through the context object 415, task state information can be queried or modified by the global scheduler, ensuring consistent task tracking and profiling throughout the system.

The task-specific configuration 410 further includes the RTOS parameters object 425 that defines low-level execution parameters required by each task instance 405, such as the task name, stack size, stack buffer, and any multicore processing (MCP) parameters. The RTOS interface cooperates with the Task Management Service 325-1 to schedule worker functions and to invoke profiling callbacks at defined execution boundaries.

The general information object 420 defines identifiers such as the core number and task number that uniquely associate each task instance 405 with a corresponding core and facilitate the aggregation of profiling data across multiple cores.

The workers object 430 represents the structured workflow of a task and is divided into three sequential phases: a pre-initialization phase 435 comprising a list of worker routines executed before task startup (e.g., resource allocation or device registration); an at-initialization phase 440 comprising worker routines executed during task initialization, such as state machine setup or inter-task binding; and a continuous phase 445 comprising one or more worker lists executed repeatedly during the steady-state phase of the task.

Across the various phases, each worker list includes a worker list identifier and list size, expressly providing information about how many routines are invoked in each phase. During execution, the task management service 325-1, …, 325-N calls each worker in the order prescribed by the corresponding list and invokes the intra-task profiling callbacks to measure timing and performance within each phase.

The callbacks object 460 defines a group of callable interfaces that are used by both local and global scheduling logic. The callbacks object 460 comprises: scheduling algorithm callbacks that control dispatch and timing of task execution among cores; task-profiling callbacks that record task-level performance data such as total execution duration, context-switch latency, and duty cycle for each task instance 405; and intra-task profiling callbacks that record worker-level performance data such as per-phase latency, jitter, and CPU utilization (e.g., per frame interval) for each worker in the workers object 430.

During operation, the task management service 325-1, …, 325-N invokes the task-profiling callback upon activation and completion of each task instance 405 to mark start and stop times. The intra-task profiling callback is invoked at a finer granularity – typically at the entry and exit of each worker routine – to capture timing, execution count, and deviations from expected real-time slice durations. The profiling data is written to the counters associated with the task instance 405 and then synchronized through the global configuration 455.

The global configuration object 455 provides system-wide synchronization among the multiple task management services 325-1, …, 325-N executing on different cores. The global configuration object 455 maintains the callbacks object 460 shared across cores, allowing uniform invocation of the task-profiling and intra-task profiling functions; and a general global information object 465, including the system kernel configuration and the number of active cores.

In this way, the global configuration object 455 operates as the unifying control plane that aggregates all profiling data, harmonizes task scheduling, and synchronizes task states between cores.

The global task instance object 450 maintains aggregated task and profiling information collected from all cores. The global task instance object 450 comprises general information such as core identification and task references, and configuration references, linking to the relevant task-specific configuration object 410 within each context object 415.

The global task instance object 450 serves as a consolidated profiling object that can be queried by the global scheduler to evaluate performance across the entire multicore system. The global task instance object 450 enables the generation of synchronized performance reports identifying performance metrics such as per-core timing drift, worker-level latency, and task execution jitter.

FIG. 5 is an example method 500 of managing tasks within an AMP system in accordance with certain embodiments. The method 500 may be used in conjunction with other embodiments, such as being performed by one or more of the task management services 325-1, …, 325-N of FIG. 3.

The method 500 begins at block 505, where the task management services 325-1, …, 325-N, which are executing on respective cores of the multicore processor system, instantiate a plurality of task instances. Each task instance is associated with a task-specific configuration comprising a real-time operating system (RTOS) parameter set, general task identifiers, and a plurality of workers.

At block 515, each task instance executes one or more workers of the plurality of workers according to a predefined execution phase including a pre-initialization phase, an initialization phase, and a continuous phase.

At block 525, one or more of the task management services 325-1, …, 325-N invoke a task-profiling callback associated with each task instance to record task-level performance data during execution of the one or more workers. In some embodiments, the task-profiling callback further records task-level duty cycle and context switch latency. In some embodiments, invoking the task-profiling callback comprises recording a start time and a stop time for each execution slice of the task instance, and computing an execution duration for real-time scheduling analysis.

At block 535, one or more of the task management services 325-1, …, 325-N invoke an intra-task profiling callback associated with each worker of the task instance to record intra-task performance data within each execution phase. In some embodiments, the intra-task profiling callback further records worker-level latency, jitter, and CPU utilization metrics. In some embodiments, invoking the intra-task profiling callback comprises monitoring execution timing of each worker within the continuous phase, and detecting a deviation in a worker execution duration relative to a predefined real-time slice.

At block 545, and by a global configuration accessible to the task management services 325-1, …, 325-N, the AMP system synchronizes the task-level performance data and the intra-task performance data to provide unified profiling of the task instances executing across the cores. In some embodiments, synchronizing the task-level performance data and the intra-task performance data comprises aggregating the recorded profiling data from the plurality of task management services into a global task instance object maintained in the global configuration.

At block 555, the AMP system dynamically adjusts a scheduling algorithm parameter in response to the task-level performance data and the intra-task performance data. For example, in some embodiments, the task management service dynamically modifies scheduling parameters of the RTOS in response to analysis of the recorded task-level performance data and worker-level performance data to balance workload across the plurality of processing cores. The scheduling algorithm parameter is accessible through a callback interface of the global configuration.

At block 565, the AMP system generates, based on the synchronized task-level performance data and intra-task performance data, a performance report indicating per-core task execution timing and intra-task phase performance for each task instance. The performance report is used to adjust task priority or core assignment within the multicore processing system.

The descriptions of the various embodiments of the present disclosure have been presented for purposes of illustration. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

In the preceding, reference is made to embodiments presented in this disclosure. However, the scope of the present disclosure may exceed the specific described embodiments. Instead, any combination of the features and elements, whether related to different embodiments, is contemplated to implement and practice contemplated embodiments. Furthermore, although embodiments disclosed herein may achieve advantages over other possible solutions or over the prior art, the embodiments may achieve some advantages or no particular advantage. Thus, the aspects, features, embodiments and advantages discussed herein are merely illustrative.

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.”

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment ("CPP embodiment" or “CPP”) is a term used in the present disclosure to describe any set of one, or more, storage media (also called "mediums") collectively included in a set of one, or more, storage devices that collectively include machine readable code corresponding to instructions and/or data for performing computer operations specified in a given CPP claim. A "storage device" is any tangible device that can retain and store instructions for use by a one or more computer processing devices. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Certain types of storage devices that include these mediums include: diskette, hard disk, random access memory (RAM), read only memory (ROM), erasable programmable read only memory (EPROM or Flash memory), static random access memory (SRAM), compact disc read only memory (CD-ROM), digital versatile disk (DVD), memory stick, floppy disk, mechanically encoded device (such as punch cards or pits / lands formed in a major surface of a disc) or any suitable combination of the foregoing. A computer readable storage medium, as that term is used in the present disclosure, refers to non-transitory storage rather than transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but the storage device remains non-transitory during these processes because the data remains non-transitory while stored.

In the claims:

1. A computer-implemented method for managing execution of real-time tasks in a multicore processor system, the method comprising:
instantiating, by task management services executing on respective cores of the multicore processor system, a plurality of task instances;
executing, by each task instance, one or more workers of a plurality of workers associated with the plurality of task instances;
invoking, by the task management service, a task-profiling callback associated with each task instance to record task-level performance data during execution of the one or more workers;
invoking, by the task management service, an intra-task profiling callback associated with each worker of the task instance to record intra-task performance data within each execution phase; and
synchronizing, by a global configuration accessible to the task management services, the task-level performance data and the intra-task performance data to provide unified profiling of the task instances executing across the cores.

2. The method of claim 1, wherein each task instance is associated with a task-specific configuration comprising a real-time operating system (RTOS) parameter set, general task identifiers, and the plurality of workers.

3. The method of claim 1, wherein invoking the task-profiling callback comprises:
recording a start time and a stop time for each execution slice of the task instance; and
computing an execution duration for real-time scheduling analysis.

4. The method of claim 1,
wherein executing the one or more workers is according to a predefined execution phase including a pre-initialization phase, an initialization phase, and a continuous phase, and
wherein invoking the intra-task profiling callback comprises:
monitoring execution timing of each worker within the continuous phase; and
detecting a deviation in a worker execution duration relative to a predefined real-time slice.

5. The method of claim 1, wherein synchronizing the task-level performance data and the intra-task performance data comprises:
aggregating the recorded task-level performance data and the intra-task performance data from the plurality of task management services into a global task instance object maintained in the global configuration.

6. The method of claim 1, further comprising:
dynamically adjusting a scheduling algorithm parameter in response to the task-level performance data and the intra-task performance data, the scheduling algorithm parameter being accessible through a callback interface of the global configuration.

7. The method of claim 1,
wherein the intra-task profiling callback further records worker-level latency, jitter, and CPU utilization metrics, and
wherein the task-profiling callback further records task-level duty cycle and context switch latency.

8. The method of claim 1, further comprising:
generating, based on the synchronized task-level performance data and intra-task performance data, a performance report indicating per-core task execution timing and intra-task phase performance for each task instance, the performance report being used to adjust task priority or core assignment within the multicore processing system.

9. A multicore processing system comprising:
a plurality of processing cores;
a real-time operating system (RTOS) executing on each of the plurality of processing cores; and
a task management service executed by the RTOS on each processing core, wherein the task management service is configured to:
instantiate a plurality of task instances associated with a plurality of workers;
invoke a task-profiling callback to record task-level performance data for each task instance;
invoke an intra-task profiling callback to record worker-level performance data; and
synchronize the recorded task-level performance data and the worker-level performance data for all task instances across the plurality of processing cores via a global configuration comprising global callbacks and global task state information.

10. The multicore processing system of claim 9, wherein each task instance is associated with a task-specific configuration comprising a real-time operating system (RTOS) parameter set, general task identifiers, and the plurality of workers.

11. The multicore processing system of claim 9, wherein the global configuration further comprises:
a global task instance maintaining aggregate task-level and intra-task profiling data from the plurality of processing cores; and
a callback structure comprising a scheduling algorithm callback, a task profiling callback, and an intra-task profiling callback.

12. The multicore processing system of claim 9, wherein the task management service dynamically modifies scheduling parameters of the RTOS in response to analysis of the recorded task-level performance data and worker-level performance data to balance workload across the plurality of processing cores.

13. The multicore processing system of claim 9,
wherein executing the one or more workers is according to a predefined execution phase including a pre-initialization phase, an initialization phase, and a continuous phase, and
wherein the intra-task profiling callback measures timing, latency, and execution counts of workers in the continuous phase, and the task-profiling callback measures overall task duration and CPU utilization per frame interval.

14. The multicore processing system of claim 9, wherein each task management service maintains a context object linking task-specific configurations and task instances, and the global configuration synchronizes the context objects among the plurality of processing cores.

15. The multicore processing system of claim 9, wherein the global configuration outputs a synchronized profiling report identifying per-core timing drift, worker-level latency, and task execution jitter.

16. A non-transitory computer-readable medium storing instructions that, when executed by one or more processors of a multicore processing system, cause the one or more processors to perform a method comprising:
instantiating a plurality of task instances;
executing one or more workers of a plurality of workers associated with the plurality of task instances;
invoking a task-profiling callback associated with each task instance to record task-level performance data during execution of the one or more workers;
invoking an intra-task profiling callback associated with each worker of the task instance to record intra-task performance data within each execution phase; and
synchronizing, by a global configuration, the task-level performance data and the intra-task performance data to provide unified profiling of the task instances executing across processing cores.

17. The non-transitory computer-readable medium of claim 16, wherein each task instance is associated with a task-specific configuration comprising a real-time operating system (RTOS) parameter set, general task identifiers, and the plurality of workers.

18. The non-transitory computer-readable medium of claim 16, wherein invoking the task-profiling callback comprises:
recording a start time and a stop time for each execution slice of the task instance; and
computing an execution duration for real-time scheduling analysis.

19. The non-transitory computer-readable medium of claim 16,
wherein executing the one or more workers is according to a predefined execution phase including a pre-initialization phase, an initialization phase, and a continuous phase, and
wherein invoking the intra-task profiling callback comprises:
monitoring execution timing of each worker within the continuous phase; and
detecting a deviation in a worker execution duration relative to a predefined real-time slice.

20. The non-transitory computer-readable medium of claim 16, wherein synchronizing the task-level performance data and the intra-task performance data comprises:
aggregating the recorded task-level performance data and the intra-task performance data from the plurality of task management services into a global task instance object maintained in the global configuration.
